(19) United States
(12) Patent Application Publication
(10) Pub. No.: US 2016/0107370 A1
(43) Pub. Date: Apr. 21, 2016

(54) Apparatus and Method for Deforming Thermoplastics

(71) Applicant: Machine Solutions, Inc., Flagstaff, AZ (US)

(72) Inventors: Joseph Gregory Augustine, Denver, CO (US); Samuel Joel Bolinger, Bloomington, IN (US); Tulsie P. Sumeer, Tucson, AZ (US)

(21) Appl. No.: 14/515,166

(22) Filed: Oct. 15, 2014

(51) Int. Cl. B29C 53/84; B29C 35/08; B29C 53/08

(52) U.S. Cl. CPC B29C 53/84; B29C 53/083; B29C 35/0805; B29C 2035/0861; B29K 2105/258

(57) ABSTRACT

A method comprises resiliently deforming the object via a mold that comprises first and second mold members that are movable between open and closed positions. The first and second mold members define a parting line or gap and a mold cavity when closed. The mold cavity is shaped such that the thermoplastic object is resiliently deformed in the mold cavity when the first and second mold members are closed. Thereafter, a portion of the mold is heated in a manner such that the object partially melts while the parting line or gap of the mold remains below the melting temperature of the object (thereby eliminating flashing). The object is then allowed to cool in the mold with the first and second mold members closed such that the object at least partially takes the shape of the mold cavity when the object is in equilibrium and is released from the mold cavity.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

The present invention pertains to thermo-deforming objects in a mold without generating flashing or parting lines. More particularly, the present invention pertains to deforming an object in a mold assembly and transferring heat to portions of the object within the mold without melting portions of the object near the parting surfaces of the mold members.

2. General Background

The fabrication of some objects involves thermoplastically deforming existing objects. For example, bent plastic tubing or rod is often formed by thermoplastically deforming a straight tube or rod. Often, the thermoplastic deformation of such tubing or rod involves heating the rod or tubing while applying a bending moment to the tubing. However, in some cases, it is desirable to thermoplastically deform an object by placing at least part of the object in a mold. A disadvantage to using molds is that flashing often occurs. While minor flashing is not problematic for many objects, for some objects flashing must be avoided. For example, bent catheter tubing (typically referred to as “pigtail” catheters) must be flashing-free to avoid scratching the inner surface of blood vessels. The present invention allows for thermoplastically mold forming such tubing without creating any flashing.

### SUMMARY OF THE INVENTION

As mentioned above, the present invention pertains to deforming an object in a mold assembly and transferring heat to portions of the object within the mold without melting portions of the object near the parting surfaces of the mold members.

One aspect of the invention pertains to a method of deforming a thermoplastic object having a melting temperature. The method comprises resiliently deforming the object via a mold. The mold comprises first and second mold members that are movable toward and apart from each other between open and closed positions. The first and second mold members define a parting line or gap and a mold cavity when in the closed position. The mold cavity has a shape such that the thermoplastic object is resiliently deformed in the mold cavity when the first and second mold members are in the closed position. Thereafter, a portion of the mold is heated with the first and second mold members in the closed position in a manner such that the object partially melts while the parting line or gap of the mold remains below the melting temperature of the object. The object is then allowed to cool in the mold with the first and second mold members in the closed position such that the object at least partially takes the shape of the mold cavity when the object is in equilibrium and is released from the mold cavity.

In another aspect of the invention, an apparatus comprises a mold having first and second mold members that are movable toward and apart from each other between open and closed positions. The first and second mold members define a parting line or gap and a mold cavity when in the closed position. The mold is configured and adapted to deform a thermoplastic object having a melting temperature. The mold cavity has a shape configured and adapted such that the thermoplastic object is resiliently deformed in the mold cavity when the first and second mold members are engaged with each other. The mold further comprises at least one heating element. The heating element is configured and adapted to heat a portion of the mold with the first and second mold members engaged with each other in a manner such that the object partially melts while the parting line or gap of the mold remains below the melting temperature of the object.

Further features and advantages of the present invention, as well as the operation of the invention, are described in detail below with reference to the accompanying drawings.

### BRIEF DESCRIPTION OF THE SEVERAL VIEWS OF THE DRAWING

FIG. 1 is a perspective view of an assembly in accordance with the invention for deforming thermoplastics, showing the top, front, and left sides thereof.

FIG. 2 is a front view of the assembly shown in FIG. 1.

FIG. 3 is a perspective view of a female mold member in accordance with the invention, showing its mating surfaces and mold cavity recess.

FIG. 4 is a perspective view of the female mold member shown in FIG. 3, showing its cavity and protrusion therein.

FIG. 5 is a rear view of the female mold member shown in FIGS. 3 and 4.

FIG. 6 is a cross-sectional view of said female mold member taken about the line 6-6 shown in FIG. 5.

FIG. 7 is another cross-sectional view of said female mold member taken about the line 7-7 shown in FIG. 5.

FIG. 8 is a perspective view of a male mold member in accordance with the invention, showing its mating surfaces and mold cavity recess.

FIG. 9 is a perspective view of the male mold member shown in FIG. 8, showing its cavity and protrusion therein.

FIG. 10 is a rear view of the male mold member shown in FIGS. 8 and 9.

FIG. 11 is a cross-sectional view of said male mold member taken about the line 11-11 shown in FIG. 10.

FIG. 12 is another cross-sectional view of said male mold member taken about the line 12-12 shown in FIG. 10.

FIG. 13 is a perspective view of an alternative male mold member in accordance with the invention having an alternative heating element and heating protrusion arrangement.

FIG. 14 is the heating element of the male mold member shown in FIG. 13.

FIG. 15 is a perspective view of yet another alternative male mold member in accordance with the invention having an alternative heating element and heating protrusion arrangement.

FIG. 16 is the heating element of the male mold member shown in FIG. 15.

FIG. 17 is a perspective view of a catheter in a mold in accordance with the invention.

FIG. 18 depicts the catheter after being molded in accordance with the invention.

Reference numerals in the written specification and in the drawing figures indicate corresponding items.

### DETAILED DESCRIPTION

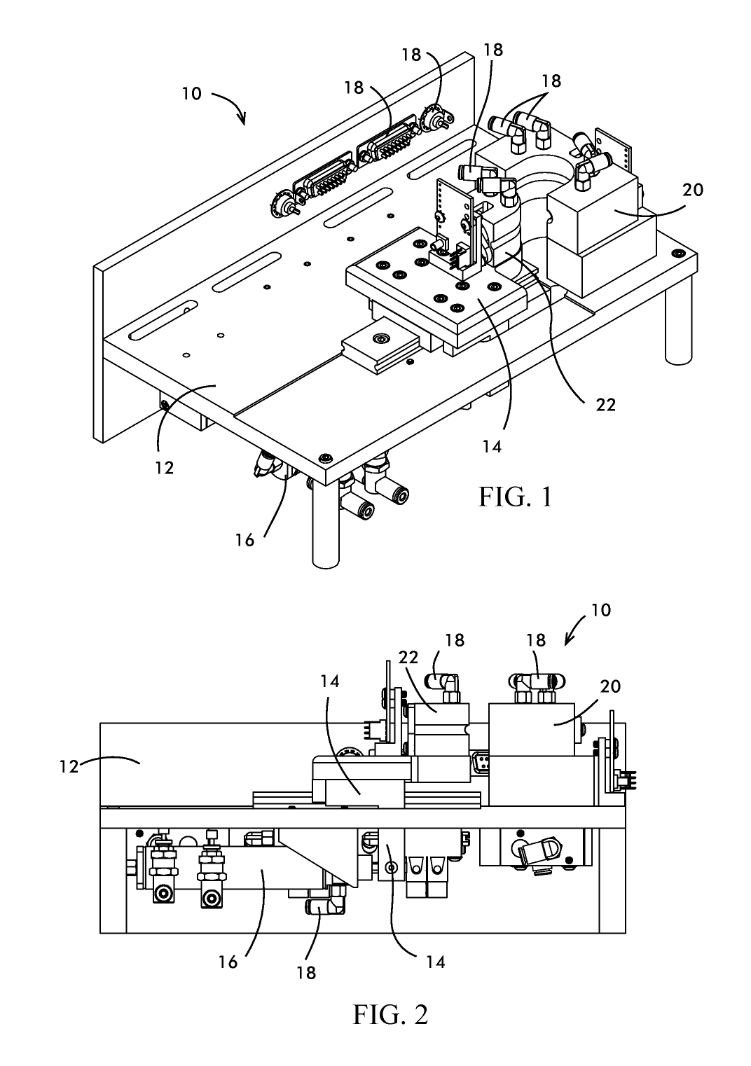

An assembly (10) in accordance with the invention for deforming thermoplastics is shown in FIGS. 1 and 2. The assembly (10) comprises a frame (12), a sliding mount (14), an actuator (16), various electrical fittings (18), a female mold member (20), and a male mold member (22). The sliding mount (14) is attached to the frame (12) in a manner such that the sliding mount can move linearly toward and away from the female mold member (20), which is fixed relative to the frame. Of course, either mold member (20, 22) could be fixed and both could be movable. Regardless, the mold members (20, 22) are therefore moveable between an open position (wherein the mold members are farthest from each other) and a closed position (wherein the mold members contact each other or are closest to each other). The actuator (16) is a linear actuator that is fixed at one end to the frame (12) and to the sliding mount (14) at its other end. Thus, the actuator (16), which may be hydraulic, electric, pneumatic, or otherwise powered, controls the movement of the sliding mount (14) relative to the frame (12). The electrical fittings (18) are provided to operatively connect all of the powered components to a CPU (not shown) for automating the operation of the assembly (10). It should be appreciated that the wire/line connections between various components have been omitted from the drawings for clarity.

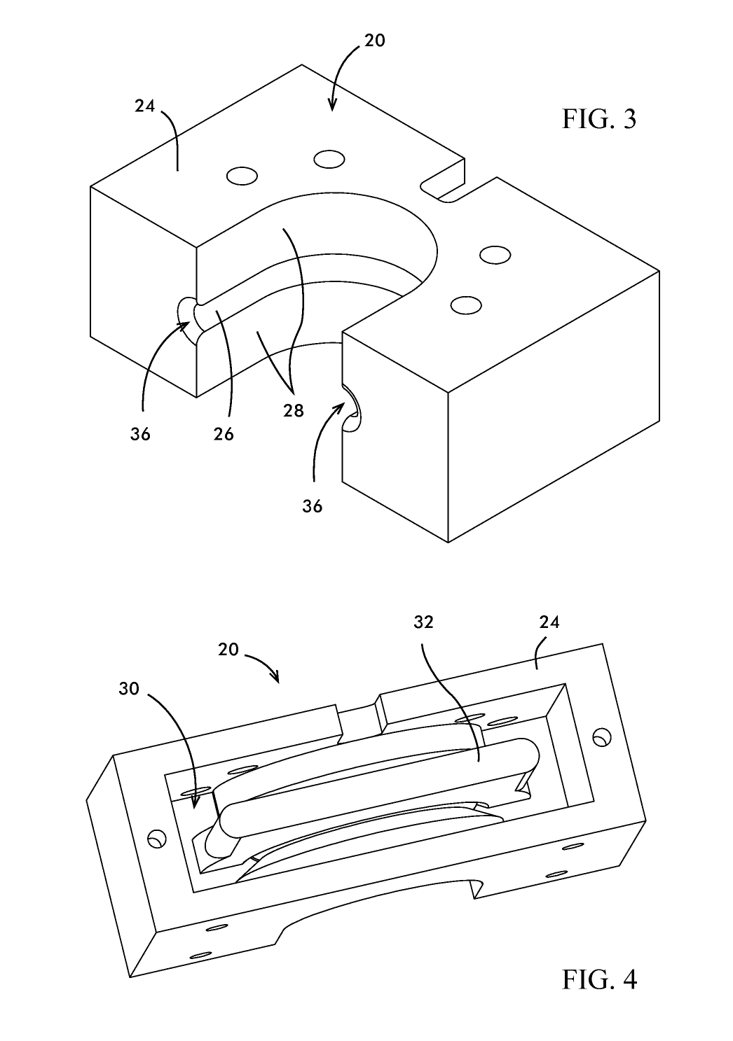

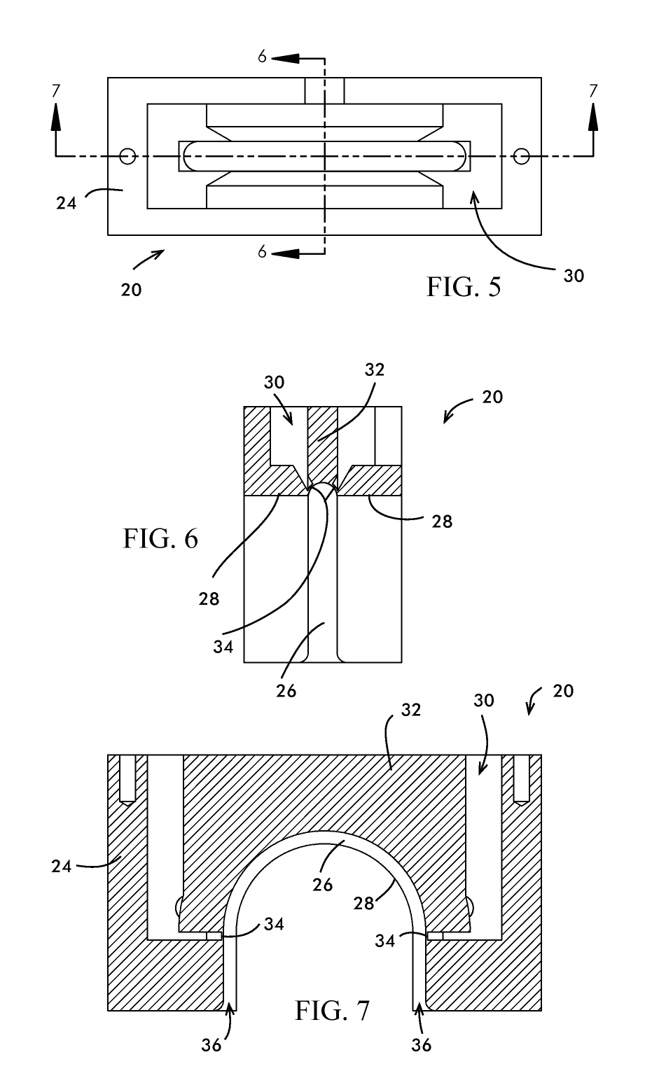

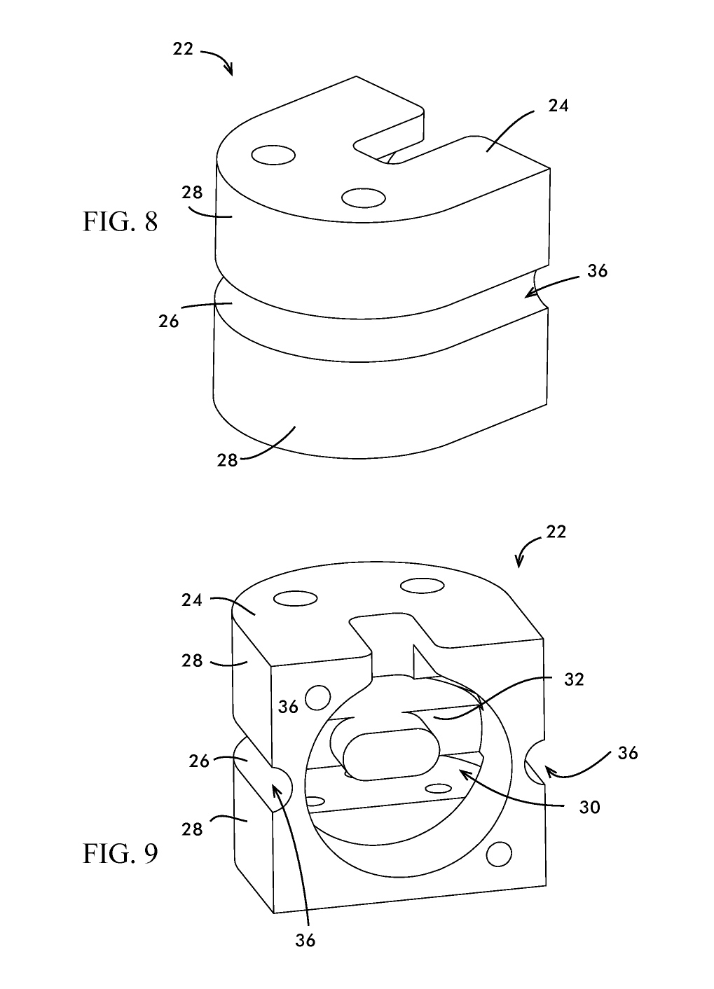

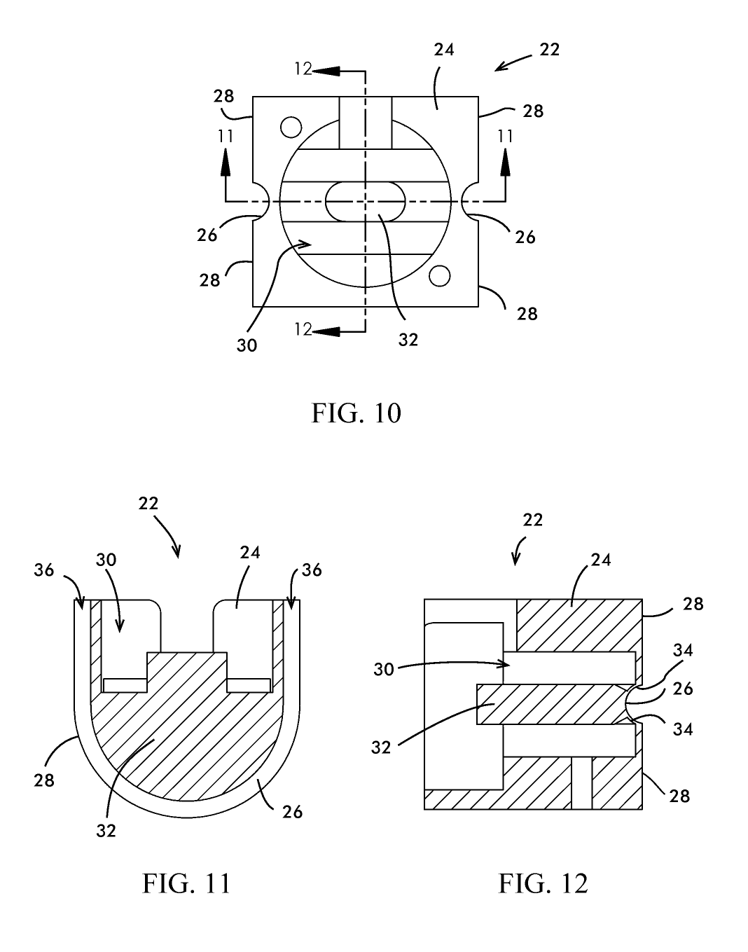

An embodiment of the female mold member (20) is shown by itself in FIGS. 3 through 7 and an embodiment of the male mold member (22) is shown in FIGS. 8 through 12. Each of the mold members (20, 22) comprises a main body portion (24), a mold cavity recess (26), parting line or gap surfaces (28), a heating element cavity (30), a heating protrusion (32), and bridge portions (34). The heating element cavity (30) extends into the main body portion (24) of the mold member (20, 22). The heating element protrusion (32) is located within the heating element cavity (30) and extends from the mold cavity recess (26). The parting line or gap surfaces (28) are the exterior surface immediately adjacent to the mold cavity recess (26) and are those surfaces that contact or are closest to the other mold member when the mold members (20, 22) are in their close position. The bridge portions (34) define part of the mold cavity recess (26) and connect the portion of mold cavity recess (26) that is formed by the heating element protrusion (32) from the main body portion (24). The bridge portions (34) are thin and therefore are relatively poor at transferring heat from the heating element protrusion (32) to the main body portion (24). Thus, heat transferred from the heating element protrusion (32) to the main body portion (24) is quickly dissipated within the main body portion (24). This ensures that the parting line or gap surfaces (28) remain below the temperature of the portion of mold cavity recess (26) that is formed by the heating element protrusion (32).

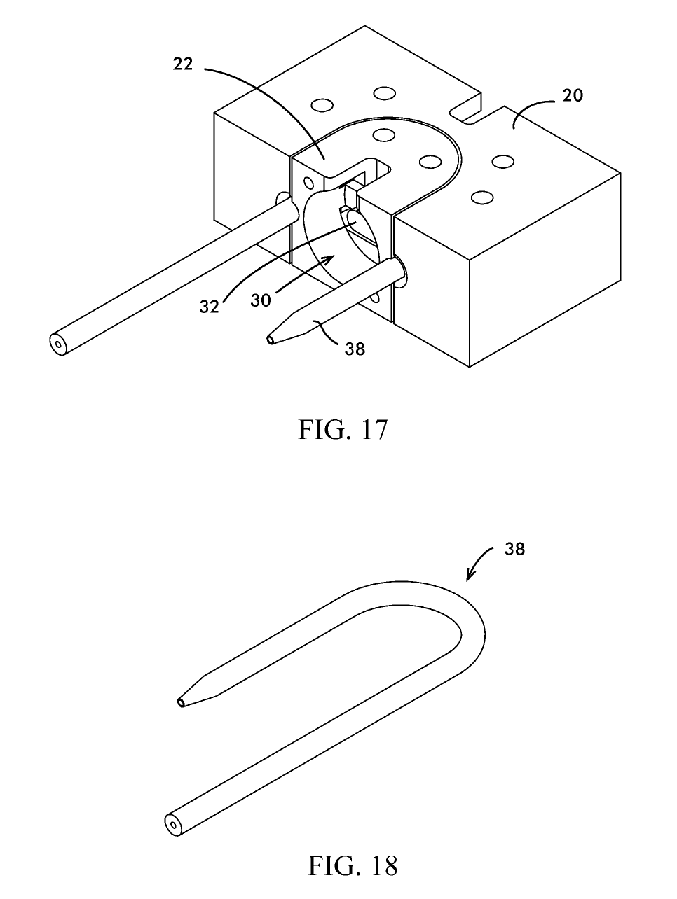

The mold cavity recesses (26) of the mold members (20, 22) shown are longitudinally U-shaped and have a semi-circular transverse shape. That shape is configured to receive a straight section of a cylindrical tube or rod and to bend that section into a U-shape as the mold members move toward their closed position. Two openings (36) that allow the cylindrical tube (38) being molded to extend out of the mold cavity recesses (26) (See FIG. 17). At the openings (36), the edges of the female mold member (20) are rounded to prevent the tubing from being scratched or hung up on what would otherwise be a sharp edge when deforming the tubing. Notably, the parting line or gap surfaces (28) are perpendicular to the U-shape of the mold cavity recesses (26). As such, the parting line or gap surfaces (28) are close to the neutral axis of the deformed tubing rather than being adjacent to the portions of maximum compression and tension in the tubing caused by the deformation. In contrast, the heating element protrusions (32) are therefore configured to direct heat the portions the cylindrical tubing (38) having the highest compression/tension, rather than to the neutral axis of the deformed tubing. Although the mold cavity recesses (26) form the U-shape described above, it should be appreciated that other shapes are possible and that orienting the parting line/gap surfaces (28) with the neutral axis of the deformed object could still be achieved.

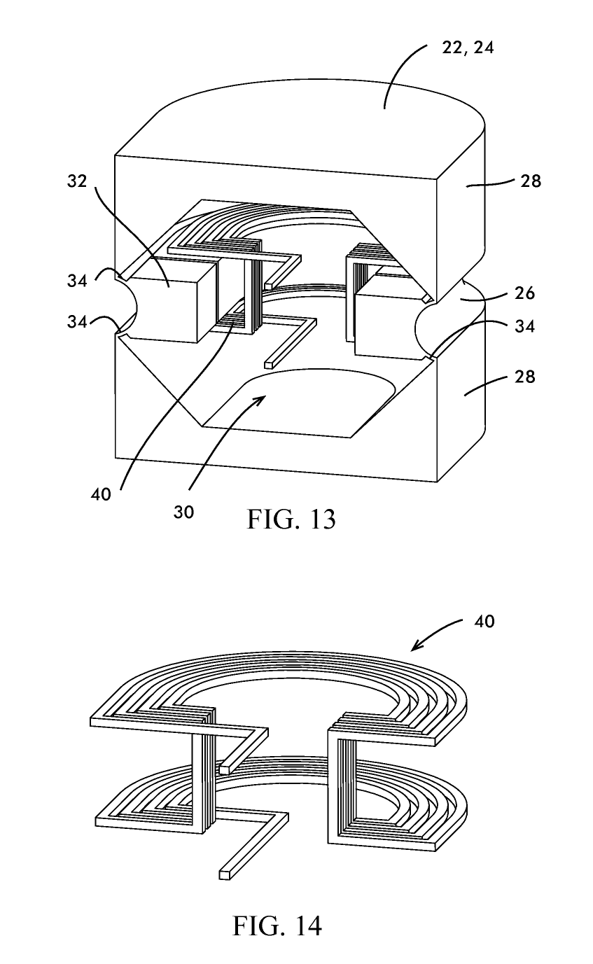

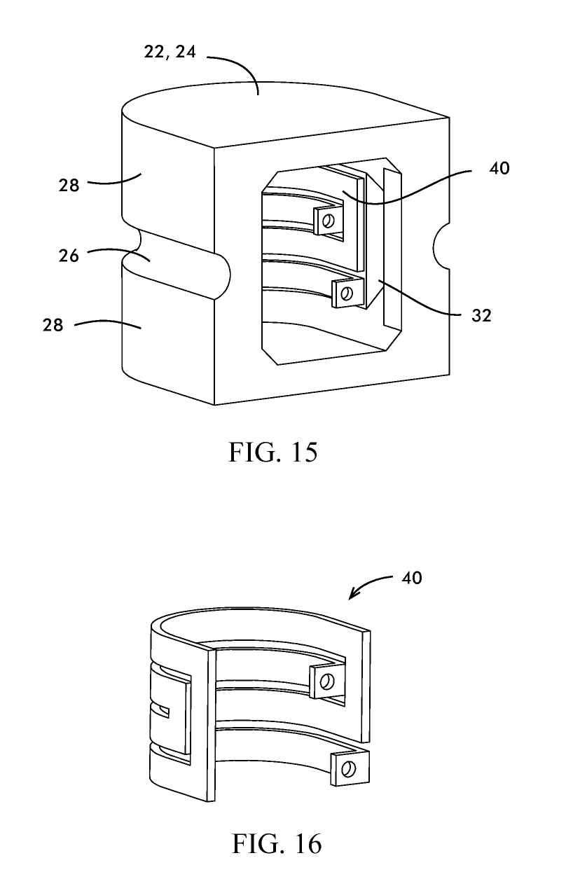

The assembly (10) preferably comprises radio frequency (RF) electric heating elements (40). Examples of such RF heating elements (40) are shown in FIGS. 14 and 16. The RF heating elements (40) are preferably formed flat and are preferably waterjet cut from a thin sheet of copper (e.g., 0.02″). The flat windings that form each heating element (40) are thereafter bent to form the desired three-dimensional shape. To maintain the proper shape and spacing of the windings when bending them, the flat windings can be sandwiched between two layers of adhesive Kapton® tape and thereafter bent. The RF heating elements (40) could also be formed as printed FLEX circuit boards. After being shaped, the RF heating elements (40) are adhered to the heating element protrusions (32) of the mold members (20, 22). As shown in FIGS. 13 and 15, the heating element protrusions (32) and the RF heating elements (40) are preferably custom shaped for each other. For example, the heating element protrusion (32) and RF heating element (40) shown in FIG. 15 are both flatter/wider than those shown in FIG. 13. Obviously, when fully installed, the RF heating elements (40) are operatively connected to the control system of the assembly via some of the electrical fittings 18.

During operation, a straight section of cylindrical thermoplastic tubing (38) (e.g., a catheter tube) can be placed between the mold cavity recesses (26) with the mold members (20, 22) in their opened position. The actuator (16) of the assembly (10) can then be triggered to move the mold members (20, 22) toward each other and into their closed position. That bends and deforms the section of cylindrical tubing (38) within the mold cavity recesses (26). With the mold members (20, 22) in the closed position, the RF heating elements (40) are energized, which rapidly heats the heating element protrusions (32) of the mold members (20, 22). The heat transfers into the portion of bent cylindrical tube (38) and melts or yields the cylindrical tube in a manner that stress relieves the tube. The RF heating elements (40) are energized for only the minimal amount of time needed to stress relieve the cylindrical tubing. This occurs very quickly and without causing the parting line/gap surfaces (28) to reach the melting temperature of the cylindrical tubing (38). As such, no flashing occurs. Following these steps, the actuator (16) of the assembly (10) can then be triggered to move the mold members (20, 22) apart from each other and into their open position and the tubing (38) can be removed from the molding assembly (10). Having been stress relieved in a deformed state, the tubing (38) will thereafter maintain the deformed shape as its new undeformed shape. If desired, the process can be repeated for different portions of the tubing (38) to create spirals, wavy shapes, or three-dimension curve paths.

It should be appreciated that the invention has many uses in deforming various objects other than tubing and the like and for various materials, including metals. In general, the invention could be applicable to any method involving heat deformation of an object, where avoiding the generation flashing is a concern.

In view of the foregoing, it should be appreciated that the invention has several advantages over the prior art. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed, unless such an order is inherent or explicit.

What is claimed is:

1. A method of deforming a thermoplastic object having a melting temperature, the method comprising:
resiliently deforming the object via a mold, the mold comprising first and second mold members that are movable toward and apart from each other between open and closed positions, the first and second mold members defining a parting line or gap and a mold cavity when in the closed position, the mold cavity having a shape such that the thermoplastic object is resiliently deformed in the mold cavity when the first and second mold members are in the closed position; and thereafter,
heating a portion of the mold with the first and second mold members in the closed position in a manner such that the object partially melts while the parting line or gap of the mold remains below the melting temperature of the object; and thereafter,
allowing the object to cool in the mold with the first and second mold members in the closed position such that the object at least partially takes the shape of the mold cavity when the object is in equilibrium.

2. A method in accordance with claim 1 wherein the heating occurs via RF induction heating.

3. A method in accordance with claim 1 wherein the heating comprises generating heat inside at least one of the first and second mold members.

4. A method in accordance with claim 3 wherein the heating comprises generating heat inside each of the first and second mold members.

5. A method in accordance with claim 3 wherein the at least one of the first and second mold members comprises a heating element cavity having a protrusion therein and the method comprises generating heat within the protrusion via an RF induction heating element.

6. A method in accordance with claim 5 wherein the at least one of the first and second mold members comprises a main body portion into which the heating element cavity extends, and the main body portion functions as a heat sink during the heating of the protrusion by drawing heat from the parting line or gap.

7. A method in accordance with claim 1 wherein the object is an elongate tube, the mold is configured such that two openings are in communication with the mold cavity when the first and second mold members are in the closed position, and the elongate tube extends out of both openings of the mold when the elongate tube is resiliently deformed via the mold.

8. A method in accordance with claim 7 wherein the elongate tube is initially straight and the mold cavity is a passageway that curves as it extends from one of the openings of the mold to the other opening.

9. A method in accordance with claim 8 wherein the elongate tube is a catheter, and the method is repeated in a manner such that the catheter ends up having a spiral or helical portion.

10. An apparatus comprising:
a mold, the mold comprising first and second mold members that are movable toward and apart from each other between open and closed positions, the first and second mold members defining a parting line or gap and a mold cavity when in the closed position, the mold being configured and adapted to deform a thermoplastic object having a melting temperature, the mold cavity having a shape configured and adapted such that the thermoplastic object is resiliently deformed in the mold cavity when the first and second mold members are engaged with each other;
at least one heating element, the heating element being configured and adapted to heat a portion of the mold with the first and second mold members engaged with each other in a manner such that the object partially melts while the parting line or gap of the mold remains below the melting temperature of the object.

11. An apparatus in accordance with claim 10 wherein the heating element is an RF induction heating element and is configured to generate heat inside at least one of the first and second mold members.

12. An apparatus in accordance with claim 11 wherein the at least one of the first and second mold members comprises a heating element cavity having a protrusion therein, and the RF induction heating element is configured and adapted to generate heat within the protrusion.

13. An apparatus in accordance with claim 12 wherein the at least one of the first and second mold members comprises a main body portion into which the heating element cavity extends, and the main body portion is configured and adapted to function as a heat sink to draw heat from the parting line or gap when the RF induction heating element generates heat within the protrusion.

14. An apparatus in accordance with claim 10 wherein the mold comprises at least one opening in communication with the mold cavity when the first and second mold members are in the closed position and the mold is configured such that a thermoplastic object can extend out of the opening of the mold when the first and second mold members are in the closed position.

15. An apparatus in accordance with claim 10 wherein the mold cavity is a passageway that curves along a planer path, and the first and second mold members each have a surface that bounds the parting line or gap and that is perpendicular to the planer path.
